(19) United States
(12) Patent Application Publication
(10) Pub. No.: US 2026/0152695 A1
(43) Pub. Date: Jun. 4, 2026

(54) MERCAPTAN SCAVENGER ADDITIVES

(71) Applicant: Cameron International Corporation, Houston, TX (US)

(72) Inventors: Pradyumna DESHPANDE, Aberdeen (GB); Rolando PEREZ PINEIRO, Nisku (CA); Jody HOSHOWSKI, Nisku (CA); Alyn JENKINS, Aberdeen (GB)

(21) Appl. No.: 19/125,312

(22) PCT Filed: Oct. 31, 2023
(86) PCT No.: PCT/US2023/036437

§ 371 Date: Apr. 29, 2025

Related U.S. Application Data
(60) Provisional application No. 63/381,582, filed on Oct. 31, 2022.

(51) Int. Cl. C10G 29/22

(52) U.S. Cl. CPC C10G 29/22; C10G 2300/202; C10G 2300/207; C10G 2300/70

(57) ABSTRACT

Embodiments described herein provide materials and methods for scavenging mercaptans in a hydrocarbon production context. Mercaptan scavenging methods include adding a branched or hyperbranched polyacrylate material to a target material comprising hydrocarbon and mercaptans; and reacting the polyacrylate material with the mercaptans to form a thioether.

### CROSS-REFERENCE TO RELATED APPLICATIONS

This patent application claims benefit of U.S. Provisional Patent Application Ser. No. 63/381,582 filed Oct. 31, 2022, which is entirely incorporated herein by reference.

### FIELD

This patent application relates to management of sulfide species in materials encountered in oilfield operations. Specifically, this application is related to the use of branched or hyperbranched polyacrylates for scavenging mercaptans in oilfield operations.

### BACKGROUND

Mercaptans, or thiols, are organosulfur compounds that have undesirable characteristics. They smell bad, they can cause corrosion in steel processing equipment, and they are regulated. For these reasons, among others, operators who refine crude oil and gas into petroleum products have strict specifications limiting the amount of mercaptans their feedstocks can have. Accordingly, mercaptans are routinely removed from crude oil and gas produced from hydrocarbon reservoirs. Conventional processes for removing mercaptans include catalytic processes such as the Merox oxidation process, and processes with specific mechanical configurations such as the various Merichem processes. In some cases, conventional mercaptan removal processes generate wastes that must be managed or recycled, or have specific equipment configurations that must be provided at crude processing sites. Improved methods for removing mercaptans from produced hydrocarbons are needed.

### SUMMARY

Embodiments described herein provide a method, comprising adding a branched polyacrylate material to a target material comprising hydrocarbon and mercaptans; and reacting the branched polyacrylate material with the mercaptans to form a thioether.

Other embodiments described herein provide a method, comprising obtaining a scavenging composition comprising a branched polyacrylate material dispersed in a solvent; and adding the scavenging composition to a target material comprising hydrocarbon and mercaptans in an amount to reduce the concentration of mercaptans in the target material to a predetermined level.

### DETAILED DESCRIPTION

Polyacrylates are compounds that contain more than one acrylate moiety. Terminal acrylates, in particular are known to react with mercaptan via Michael addition to yield corresponding thioethers. A class of such compounds that do not react with hydrogen sulfide (H₂S) have surprisingly been found to react with mercaptans with useful conversion. The compounds described herein are branched or hyperbranched (i.e. molecules having branching index greater than 1) unsaturated poly-functional acrylates having multiple unsaturated acrylate groups per molecule (i.e. a “polyacrylate functionality” of greater than 1 mole⁻¹). The compounds can be small molecules or oligomers, generally having molecular weight less than about 5,000 Daltons and a branched or hyperbranched molecular backbone. In some cases, molecules usable for methods herein have polyacrylate functionality of 6-18. The molecular backbone can be a simple alkyl (hydrocarbyl, hydrogen and carbon) backbone, which can have some hydrogen atoms replaced with other atoms, such as oxygen, nitrogen, phosphorus, or sulfur, or substituent groups that can be hydrocarbyl groups or other organic groups that have atoms such as oxygen, nitrogen, phosphorus, and/or sulfur as part of the substituent group. The molecular backbone can also be an ester, ether, urethane, polyurethane, polyester, or polyether backbone, or a combination thereof. Other molecular backbones that can be used include butadiene, styrene, other olefins, thioether, imine, and silicone. Multi-polymer backbones can also be used that include any of the above backbone types in block or random distribution. The acrylate groups can generally be acrylate or methacrylate groups, which will generally be referred to herein as “acrylate groups.”

Polyacrylates that can be used in the methods described herein have one of the general formulas below:

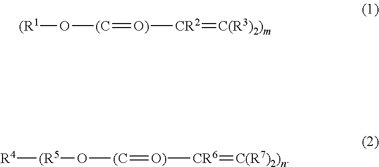

In formula 1, while m is an integer representing a number of acrylate units, or acrylate-containing units, that are linearly and sequentially attached. In most cases, m is 2 or more, such as 2-22, for example 6-18. In formula 2, n is an integer representing a number of acrylate units attached to group R⁴ in a hyperbranched or dendritic structure. In most cases, n is at least 6, such as 6-22, for example 6-18. Thus, a polyacrylate molecule useful for the purposes described herein can be made of linearly attached acrylate units that can have some branching, or of hyperbranched acrylate units.

The linearly attached acrylate units are usually branched to at least some degree. Thus, any combination of R¹, R², and R³ can be branched organic or hetero-organic groups. In general, R¹ is an organic or hetero-organic group, R⁴ is an organic or hetero-organic dendritic structure (dendrimer), R⁵ is an optional organic or hetero-organic group, and R², R³, R⁶, and R⁷ are hydrogen or an organic or hetero-organic group, where in each instance R¹ can be the same or different, R² can be the same or different, R³ can be the same or different, R⁵ can be the same or different, R⁶ can be the same or different, and R⁷ can be the same or different. In some embodiments, as noted above, m or n is from 6 to 18. In general, each instance of R¹ and R⁴ can, independently, be alkyl; alkenyl; substituted alkyl or alkenyl; hetero-substituted alkyl or alkenyl substituted with hetero-atoms such as phosphorus, nitrogen, oxygen, and/or sulfur; amine; ester or polyester; ether or polyether; butadiene or polybutadiene; urethane or polyurethane; epoxy; aromatic components such as styrene, polystyrene, and benzyl polymers such as poly benzylethers and poly benzyl silicones; olefin or polyolefin; polyisocyanate; thioether; imine or polyimine; and silicone. These molecules act as scavengers for mercaptans without substantially reacting with H₂S. These scavenger molecules are generally oil soluble and miscible in solvents such as pentane, hexane, heptane, toluene, xylene, naphtha, Aromatic 100, Aromatic 150, Aromatic 150ND, ethylene glycol monobutyl ether (EGMBE), 2-ethyl hexanol, diesel, biodiesel, base oil, and mixtures thereof. Mixtures of the foregoing scavenger molecules can also be used.

In some embodiments of formula 1, R² and R³ are organic groups that do not have substantial electronegativity or electron withdrawing components close to the carbon atoms participating in the carbon-carbon double bond. For example, R² and R³ can be aliphatic hydrocarbyl groups, which can be saturated or unsaturated. R² and R³ could include hetero atoms such as nitrogen, sulfur, and oxygen where at least one carbon atom is between the hetero atom and a carbon atom of an acrylate double bond.

Several materials sold under the Miramer® brand, of Miwon Specialty Chemical Co. Ltd., Yongin-si, South Korea, can be used for methods herein. Examples include Miramer M222 (dipropylene glycol diacrylate), M282 (polyethylene glycol 200 diacrylate), SP1106 (dendritic acrylate), LR3600 (amine acrylate), U360 (aliphatic hexafunctional acrylate), and M4004 will react with mercaptans in a hydrocarbon material, or hydrocarbon-water mixture, without reacting with H₂S. Using such materials as mercaptan scavengers allows scavenging of mercaptans without the scavenger material being consumed by H₂S in the target material. Oligomer products available from Bomar, of Torrington, Connecticut, that have acrylate functionality of at least 2 (i.e. at least two acrylate functional groups per molecule) can also be used.

The mercaptan scavenging acrylate materials described herein are dispersed or dissolved in a medium to facilitate addition to a target material. The target material is typically a stream of material that comprises a mixture of hydrocarbon materials impurities and water emerging from a well formed in the earth. The mercaptan scavenger materials and the medium constitute a mercaptan scavenging composition that is added to the target material at a convenient location away from the wellhead where the target material emerges from the earth. The mercaptan scavenging composition can be added directly to a pipe in which the target material is flowing, or a vessel can be provided for accepting the target material and for contacting the target material with the mercaptan scavenging material.

The medium is typically a material that is miscible with the hydrocarbon component of the target material. The medium may also be able to dissolve the mercaptan scavenger. Materials that can dissolve the mercaptan scavengers herein and are miscible with typical hydrocarbon materials include aromatic solvents such as benzene, toluene, xylene, naphthalene or derivatives thereof. In some cases, mercaptan scavengers described herein can be used without a dispersion medium where flowability of the mercaptan scavenger can be maintained for adding to a produced stream. In some cases, a medium can be used to disperse the mercaptan scavengers described herein without dissolving them. Such a medium could be a hydrocarbon-miscible material, such as a hydrocarbon solvent, that does not dissolve the mercaptan scavenger but can form a dispersion of the scavenger, such as a colloid or slurry. Upon adding such a material to the target material, the solvent blends with, and dissolves into the hydrocarbon component of the target material, and components of the target material can then dissolve the mercaptan scavenger materials to facilitate the scavenging reaction of the acrylate materials with the mercaptans in the target material.

Catalyst can be included to facilitate the scavenging reaction. Catalysts are generally basic, and may be inorganic or organic bases. Metal hydroxides such as sodium hydroxide, potassium hydroxide, and calcium hydroxide can be used. Alkyl and alkanol amines such as hexylamine, monoethanolamine, diethanolamine, and triethanolamine can be used with varying efficiency. In addition to, or instead of, simple alkyl and alkanol amines, molecules such as 1,8-Diazabicyclo[5.4.0]undec-7-ene (DBU), 5-Diazabicyclo[4.3.0]non-5-ene (DBN) and tertiary phosphines can also be used as catalysts.

Depending on the type of molecule used for mercaptan scavenging, for example number of acrylate groups per unit mass of the mercaptan scavenger, scavengers can be used at a dose rate of 0.5 ppm to 18 ppm per 1 ppm of mercaptan. For diacrylate scavengers, the dose rate is generally 0.5 ppm to 5 ppm per 1 ppm of mercaptan, and for dendritic acrylates the dose rate is generally 4 ppm to 18 ppm per 1 ppm of mercaptan. Hyperbranched diacrylates can be dosed at a rate of 1 ppm per 2 ppm of mercaptan, and dendritic acrylates can be dosed at a rate of 1 ppm per 18 ppm mercaptan. These dose rates will reduce mercaptan concentration to undetectable levels in a target material. Lower dose rates can be used to reduce mercaptan levels to a degree short of undetectability.

The acrylate mercaptan scavengers described herein can be tailored to distribute between hydrocarbon and water phases in the target material, and to perform under a variety of environmental conditions. Low molecular weight polyacrylate materials can be used where low temperatures might be encountered, for example. Charge distribution and dipole moment content can be adjusted in acrylate materials by including groups and/or hetero-atoms to provide more or less water solubility as needed. For example, blocks of different molecular components having different affinities for water, and also having acrylate groups, can be bonded into a polyacrylate mercaptan scavenger molecule having tailored charge distributions.

A mercaptan scavenging composition can also include materials to scavenge H₂S in the target material. To a scavenging composition comprising an acrylate material dispersed in a solvent, an H₂S scavenging material can also be added. Such materials can include materials such as triazine, glyoxal, sulfolane, diisopropanolamine, piperazine, N-nitrosomethylethylamine, hemiacetal, metal carboxylate, Schiff bases, oxazolidone, hydantoin, lignosulfonates, oxazolidine, aldehydes, metal hydroxides, ethanolamines, and mixtures thereof. Molecules having combinations of the above attributes can also be used. For example, a molecule comprising oxazolidine bonded to ethanolamine (i.e. where one hydrogen atom of ethanolamine is replaced by a bond to an oxazolidine group) could be used, and other similar combination molecules can be used. Some of these molecules can also catalyze the scavenging action of acrylates in the composition, as noted above.

In general, quantities of mercaptan and H₂S scavengers used are based on an expected amount of such impurities in a target material, but excess amounts can be used, if desired, to ensure full capture of mercaptans and H₂S. Where solubility of a scavenger is limited, larger quantities of the scavenger composition can be used to deliver sufficient quantities of scavenger into the target material.

The preceding description has been presented with reference to present embodiments. Persons skilled in the art and technology to which this disclosure pertains will appreciate that alterations and changes in the described structures and methods of operation can be practiced without meaningfully departing from the principle, and scope of this present disclosure. Accordingly, the foregoing description should not be read as pertaining only to the precise structures described and shown in the accompanying drawings, but rather should be read as consistent with and as support for the following claims, which are to have their fullest and fairest scope.

1. A method, comprising:
adding a branched polyacrylate material to a target material comprising hydrocarbon and mercaptans; and
reacting the branched polyacrylate material with the mercaptans to form a thioether.

2. The method of claim 1, wherein the branched polyacrylate material is a molecule having 2 to 18 acrylate groups.

3. The method of claim 1, further comprising dispersing the branched polyacrylate material in an aromatic solvent.

4. The method of claim 1, further comprising adding an H₂S scavenging material to the target material.

5. The method of claim 1, wherein the branched polyacrylate material is dispersed in a solvent to form a scavenging composition, and the branched polyacrylate material is added to the target material by adding the scavenging material to the target material.

6. The method of claim 5, further comprising adding an H₂S scavenging material to the scavenging composition.

7. The method of claim 1, wherein the branched polyacrylate material is a hyperbranched polyacrylate material.

8. A method, comprising:
obtaining a scavenging composition comprising a branched polyacrylate material dispersed in a solvent; and
adding the scavenging composition to a target material comprising hydrocarbon and mercaptans in an amount to reduce the concentration of mercaptans in the target material to a predetermined level.

9. The method of claim 8, wherein the branched polyacrylate material is a molecule having 2 to 18 acrylate groups.

10. The method of claim 8, wherein the solvent is an aromatic solvent.

11. The method of claim 10, wherein the scavenging composition further comprises an H2S scavenger.

12. The method of claim 8, wherein the branched polyacrylate material is a hyperbranched polyacrylate material.

13. The method of claim 8, wherein the scavenging composition further comprises a catalyst.

14. The method of claim 8, wherein the branched polyacrylate material has an acrylate functionality from 6 to 18.

15. The method of claim 8, wherein the branched polyacrylate material is one of dipropylene glycol diacrylate, polyethylene glycol 200 diacrylate, dendritic acrylate, amine acrylate, an aliphatic hexafunctional acrylate, or a combination thereof.

16. The method of claim 8, wherein the branched polyacrylate material comprises a compound of the general formula 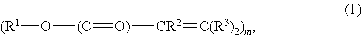
a compound of the general formula 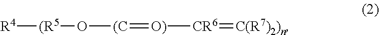
or a combination thereof, wherein m is 2 or more, n is at least 6, R¹, R², and R³ are each a branched organic or hetero-organic group, R⁴ is an organic or hetero-organic dendritic structure, R⁵ is an optional organic or hetero-organic group, and R⁶ and R⁷ are each hydrogen or an organic or hetero-organic group.

17. The method of claim 16, wherein m is 6 to 18 and n is 6 to 18.

18. The method of claim 16, wherein each instance of R¹ and R⁴ is, independently, alkyl; alkenyl; substituted alkyl or alkenyl; hetero-substituted alkyl or alkenyl substituted with hetero-atoms; amine; ester or polyester; ether or polyether; butadiene or polybutadiene; urethane or polyurethane; epoxy; an aromatic group; a benzyl polymer; olefin or polyolefin; polyisocyanate; thioether; imine or polyimine; or a silicone.

19. A method, comprising:
obtaining a scavenging composition comprising a branched polyacrylate material dispersed in an aromatic solvent, the branched polyacrylate material comprising a compound of the general formula 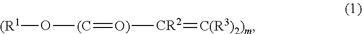
a compound of the general formula 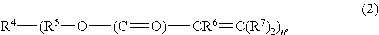
or a combination thereof, wherein m is 2 or more, n is at least 6, R¹, R², and R³ are each a branched organic or hetero-organic group, R⁴ is an organic or hetero-organic dendritic structure, R⁵ is an optional organic or hetero-organic group, and R⁶ and R⁷ are each hydrogen or an organic or hetero-organic group; and
adding the scavenging composition to a target material comprising hydrocarbon and mercaptans in an amount to reduce the concentration of mercaptans in the target material to a predetermined level.

20. The method of claim 19, wherein m is 6 to 18 and n is 6 to 18.
